(19) United States
(12) Patent Application Publication
(10) Pub. No.: US 2005/0069159 A1
(43) Pub. Date: Mar. 31, 2005

(54) Electronic apparatus having a speaker unit

(75) Inventor: Takahiro Nakazato, Tachikawa-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/896,018

(22) Filed: Jul. 22, 2004

(30) Foreign Application Priority Data
Sep. 29, 2003 (JP) 2003-337748

(51) Int. Cl. H04R 5/02; H04R 1/02

(52) U.S. Cl. 381/306; 381/333; 381/388

(57) ABSTRACT

An electronic apparatus comprising a housing having an outer surface and a keyboard provided on the housing and exposed outside the housing. The outer surface of the housing has a palm rest in front of the keyboard and a speaker receptacle on the side of the keyboard and the palm rest. A speaker unit is provided in the speaker receptacle. The speaker unit can be rotated between a first position where the speaker unit is held in the speaker receptacle and a second position where the speaker unit protrudes from the speaker receptacle.

### CROSS-REFERENCE TO RELATED APPLICATIONS

This application is based upon and claims the benefit of priority from prior Japanese Patent Application No. 2003-337748, filed Sep. 29, 2003, the entire contents of which are incorporated herein by reference.

### BACKGROUND OF THE INVENTION

1. Field of the Invention

The present invention relates to an electronic apparatus such a portable computer having a speaker unit.

2. Description of the Related Art

Some of electronic apparatuses, such as portable computers, have speakers. An apparatus having speakers is disclosed in Jpn. Pat. Appln. KOKAI Publication No. 2000-172373. The main unit of this apparatus has a receptacle for accommodating a speaker unit that comprises two speakers. The receptacle open at the front of the main unit. The receptacle holds a hinge unit. The hinge unit can be removed from the receptacle. The speaker unit is connected to the hinge unit by a hinge mechanism.

When operated, the speaker unit generates sound. The sound comes out at the openings made in the sides of the main unit while the speaker unit remains in the receptacles. Once the speaker unit is pulled out forward from the receptacle, the sound goes upwards because the speaker unit faces the top of the main unit. After pulled out of the receptacle, the speaker unit can be rotated by 90° from the top-facing position to a front-facing position. (In the front-facing position, the speaker unit has its distal end lying below.)

Jpn. Pat. Appln. KOKAI Publication No. 2000-172373 discloses another type of an electronic apparatus that has two speaker unit receptacles. This apparatus has a pair of speaker units. In the main unit of the apparatus, both speaker units are so positioned that the sound they generate goes upwards. Each of the speaker units can be pulled from the receptacle to pop out from the sides of the main unit. Once so pulled out, the speaker units assume only a top-facing through they can slightly rotate around a horizontal axis.

U.S. Pat. No. 6,078,497 discloses a portable electronic apparatus having a display unit that can be rotated with respect to the base unit. The base unit incorporates a pair of speaker assemblies that are shaped like a quarter of a pie. The speaker assemblies incorporate one speaker each. In the base unit, they are positioned with their sound-generating sections facing the sides of the base unit. The speaker assemblies can be rotated around a transverse axis of the base unit. Thus, their sound-generating sections can face the front of the base unit.

U.S. Pat. No. 6,078,497 discloses another type of a portable electronic apparatus that comprises a base unit, a display unit, a hinge unit, and a pair of speaker assemblies. The hinge unit enables the display unit to rotate with respect to the base unit. The speaker assemblies are incorporated in the hinge unit. The hinge unit has a middle part, a left part and a right part. The middle part couples the display unit and the base unit together. The speaker assemblies are provided on the left and right parts of the hinge unit, respectively. Each speaker assembly has a wing part, a tube part and a speaker. The speaker is provided on the wing part. In its normal position, each speaker assembly lies in the rear part of the base unit, with its outer edge located in flush with an outer surface of the portable electronic apparatus. In its normal position, each speaker assembly may alternatively lie in a recess made in the display unit, with its outer edge located in flush with an outer surface of the portable electronic apparatus. Both speaker assemblies can be pulled from the sides of the portable electronic apparatus. Once so pulled out, each speaker assembly can be rotated about the axis of its tube part.

While operating such an electronic apparatus, the user sits in front of the apparatus, looking down at the main unit (or base unit). To enable the user to hear well the sound sent forth from the speaker units (or speaker assemblies), the speaker units should better be arranged as close to the user as possible.

In the first-type electronic apparatus disclosed in Jpn. Pat. Appln. KOKAI Publication No. 2000-172373, the speaker unit can be pulled forward from the front of the main unit. In this apparatus, the speaker unit can take three positions. In the first position, it lies in the speaker unit receptacle (thus, the sound comes forth from the sides of the main unit). In the second position, it faces the top of the main unit (thus, the sound goes upwards). In the third position, it is rotated by 90° from the top-facing position to a front-facing position (thus, the sound comes horizontally from the front of the main unit. No matter which position the speaker unit takes, the sound it generates cannot propagate so that the user may hear it well.

In the second-type electronic apparatus disclosed in Jpn. Pat. Appln. KOKAI Publication No. 2000-172373, the speaker units can be pulled from the receptacle to pop from the sides of the main unit. Once so pulled out, they can assume only the top-facing position through they can slightly rotate around a horizontal axis. No matter which position the speaker units take, the sound they generate can hardly propagate so that the user may hear it well.

In the first-type portable electronic apparatus disclosed in U.S. Pat. No. 6,078,497, the speaker assemblies shaped like a quarter of a pie can be rotated around a transverse axis of the base unit. Thus, they can take two positions. In the first position, the speaker assemblies send sound from the sides of the base unit. In the second position, the speaker assemblies send sound forwards and horizontally. No matter whether they assume the first position or the second position, the sound they generate cannot propagate so that the user may hear it well.

In the second-type portable electronic apparatus disclosed in U.S. Pat. No. 6,078,497, wherein the two speaker assemblies are provided on the left and right parts of the hinge unit, respectively, only the middle part of the hinge unit couples the display unit and the base unit together. Hence, this apparatus has the problem in that the load on the middle part of the hinge unit is excessively large.

### BRIEF SUMMARY OF THE INVENTION

According to an aspect of this invention there is provided an electronic apparatus that comprises a housing having an outer surface and a keyboard provided on the housing and exposed outside the housing. The outer surface of the housing has a palm rest in front of the keyboard and a speaker receptacle on the side of the keyboard and the palm rest. The speaker unit is provided in the speaker receptacle. The speaker unit can be rotated between a first position where the speaker unit is held in the speaker receptacle and a second position where the speaker unit protrudes from the speaker receptacle.

### BRIEF DESCRIPTION OF THE SEVERAL VIEWS OF THE DRAWING

FIG. 1 is a perspective view of a portable computer according to an embodiment of this invention;

FIG. 2 is a plan view showing the main unit of the portable computer of FIG. 1;

FIG. 3 is a perspective view of a part of the main unit as observed from the front, depicting one of the two identical speaker units, which has been rotated to the standing position;

FIG. 4 is an exploded perspective view illustrating the main unit and one speaker unit of the portable computer shown in FIG. 1; and

FIG. 5 is a perspective view of said part of the main unit as observed from the back, showing the speaker unit rotated to the standing position.

### DETAILED DESCRIPTION OF THE INVENTION

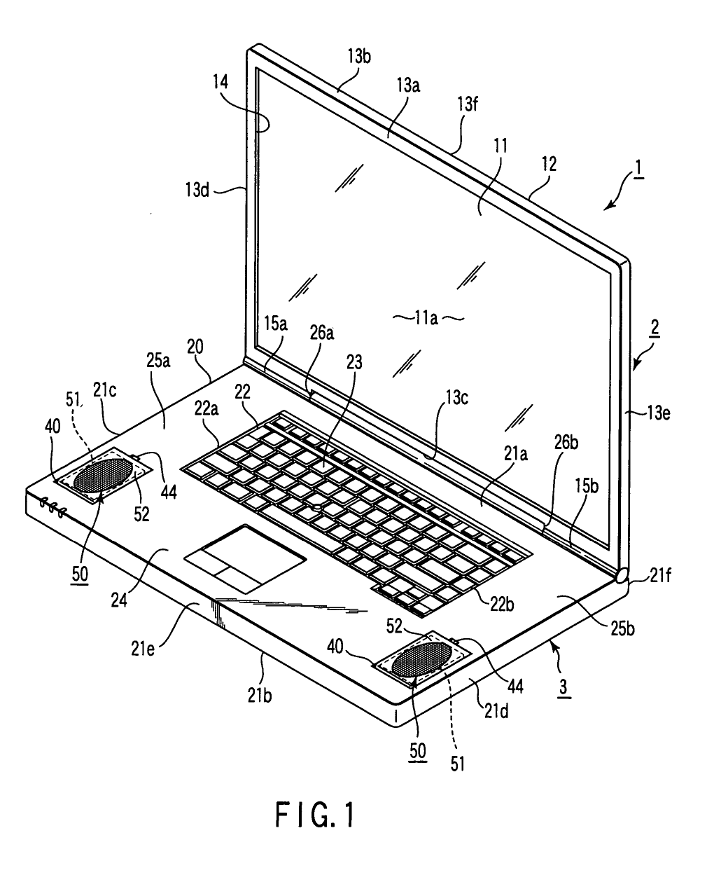

An embodiment of the present invention, or a portable computer 1, will be described with reference to FIG. 1 to 5.

As seen from FIG. 1, the portable computer 1 is a notebook-type one. The portable computer 1 comprises a display unit 2 and a main unit 3.

The display unit 2 has a liquid display panel 11 (i.e., display panel) and a display housing 12 made of synthetic resin. The liquid display panel 11 can be a large one that has a 15-inch-type (the length of the diagonal line of the panel: about 38 cm) display screen or a larger display screen. In the embodiment, the panel 11 has a 17-inch-type (the length of the diagonal line of the panel: about 43 cm) display screen 11a.

The display housing 12 holds the liquid crystal display panel 11, exposing the display screen 11a to the outside. The display housing 12 is shaped like a flat box, having a front wall 13a, four side walls 13b to 13e and a rear wall 13f. The front wall 13a has an opening 14, through which the display screen 11a is exposed. The opening 14 is a little smaller than the front wall 13a. A pair of legs 15a and 15b are provided on the lower side wall of the display housing 12. The legs 15a and 15b are spaced apart in the widthwise direction of the display housing 12.

The main unit 3 comprises a housing 20 made of synthetic resin. The housing 20 is shaped like a flat box, having top wall 21a, bottom wall 21b, left side wall 21c, right side wall 21d, front wall 21e and rear wall 21f. The outer surface 31 of the bottom wall 21b (i.e., the lower surface of the housing 20) is a mount surface. The housing 20 can be placed on an installation surface, such as the top of a desk, with its lower surface opposing the installation surface.

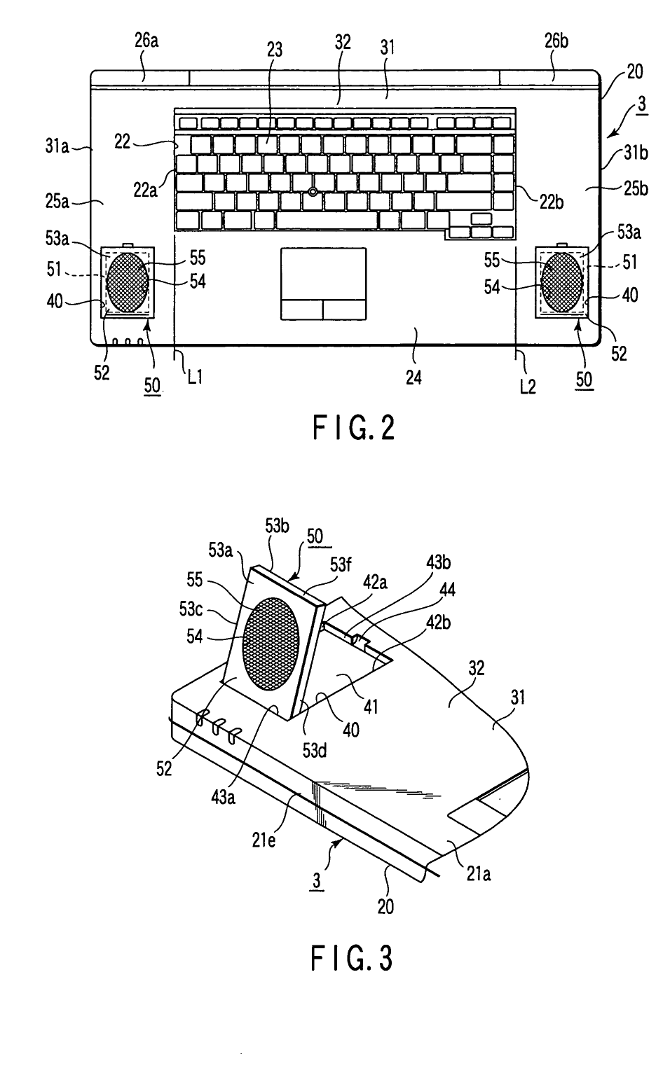

As FIGS. 1 and 2 show, the top wall 21a has a keyboard recess 22 that lies closer to the rear edge than to the front edge. The recess 22 holds a keyboard 23. Thus, the keyboard 23 is secured to the housing 20 and exposed outside.

The outer surface 31 of the top wall 21a, or the upper surface 32 of the housing 20, has a palm rest 24. The palm rest that lies between the keyboard 23 and the front edge of the top wall 21a and is juxtaposed with the keyboard 23. The palm rest 24 is that part of the outer surface 31 that is defined by the front edge of the keyboard 23, the front edge of the top wall 21a and two lines L1 and L2 (see FIG. 2). Note that the lines L1 and L2 are extensions of the left and right edges of the keyboard recess 22, respectively.

In most portable computers with a liquid crystal display panel smaller than 15-inch-type ones, the keyboard is almost as wide as the housing. That is, virtually no free regions are available at the sides of the keyboard.

By contrast, the portable computer 1 that is an embodiment of this invention has a comparatively large liquid crystal panel 11 that is a 17-inch-type panel. Thus, the housing 20 is fairly wider than the keyboard 23. Hence, there are free regions on the upper surface 32 of the housing 20, on the sides of the keyboard 23 and palm rest 24. The free region defined by the line L1 and the left edge 31a of the outer surface 31 (upper surface 32) of the top wall 21a will be hereinafter referred to as “side part 25a” (see FIG. 2). The free region defined by the line L2 and the right edge 31b of the outer surface 31 of the top wall 21a will be hereinafter referred to as “side part 25b” (see FIG. 2).

Two coupling recesses 26a and 26b are made in the rear-edge part of the housing 20. The coupling recesses 26a and 26b are spaced apart in the widthwise direction of the housing 20. The recesses 26a and 26b open upwards and backwards. The recesses 26a and 26b receive the legs 15a and 15b of the display housing 12, respectively. Hinges (not shown) support the legs 15a and 15b in the recesses 26a and 26b, allowing the legs 15a and 15b to rotate.

Therefore, the display unit 2 is coupled to the housing 20 and can rotate between a closed position and an opened position. At the closed position, the display unit 2 covers the keyboard 23, palm rest 24 and both side parts 25a and 25b from above. At the opened position, the display unit 2 stands upright, exposing the keyboard 23, palm rest 24 and both side parts 25a and 25b. Note that FIG. 1 shows the portable computer 1, with the display unit 2 held at the opened position.

The portable computer 1 has a pair of speaker units 50. The speaker units 50 are held in two speaker receptacles 40, respectively. The speaker receptacles 40 are provided in the outer surface 31 of the housing 20. More precisely, the receptacles 40 are provided in the side parts 25a and 25b of the upper surface 32 of the housing 20.

As FIGS. 3 to 5 show, either speaker receptacle 40 is a recesses. The recess is defined by, for example, a bottom surface 41, a left side surface 42a, a right side surface 42b, a front surface 43a, and a rear surface 43b. The speaker receptacle 40 has such a size that a speaker unit 50 fits in it. The receptacle 40 is so deep that the speaker unit 50 may lie down in it, with its upper surface set almost in flush with the upper surface 32 of the housing 20 (or outer surface 31 of the top wall 21a).

Two hinge sockets 45 are provided in the front parts of the side surfaces 42a and 42b, respectively. As will be described later, two hinges 58 provided on the speaker unit 50 are fitted rather tight in the hinge sockets 45.

A finger rest 44, which is a recess, is made in the upper surface 32 of the housing 20. The finger rest 44 is continuous to, for example, the rear surface 43b of the speaker receptacle 40.

The housing 20 contains speaker terminals (not shown) that electrically connect the terminals 56a of the speakers 51 to a power supply (not shown). (The speakers 51 will be described later.) One of the side surfaces of the speaker receptacle 40, e.g., the right side surface 42b, has an opening (not shown). Through this opening the speaker terminals are exposed to the speaker receptacle 40.

In order to transmit sound well from either speaker unit 50 to the user of the personal computer 1, it is desired that the speaker 51 of the unit 50 be located close to the front of the housing 20. This is why either speaker receptacle 40 is provided besides the palm rest 24.

If the speaker receptacles 40 and the speaker units 50 hinder the user from operating the keyboard 23, the receptacles 40 may be located closer to the left and right sides of the keyboard 23. Further, the speaker receptacles 40 may be arranged at the left-front and right-front corners of the keyboard 23, respectively.

Either speaker unit 50 has a speaker 51 and a housing 52 accommodating the speaker 51. As FIGS. 3 to 5 show, the housing 52 is shaped like a flat box, having top wall 53a, bottom wall 53b, left side wall 53c, right side wall 53d, front wall 53e and rear wall 53f. The corner, which is defined by the top wall 53a and front wall 53e, and the corner, which is defined by the bottom wall 53b and the front wall 53e, are rounded over the entire width of the speaker unit 50. Thus, the speaker unit 50 can be smoothly rotated, not interfering with the front edge (i.e., front surface 43a or bottom surface 41) of the speaker receptacle 40.

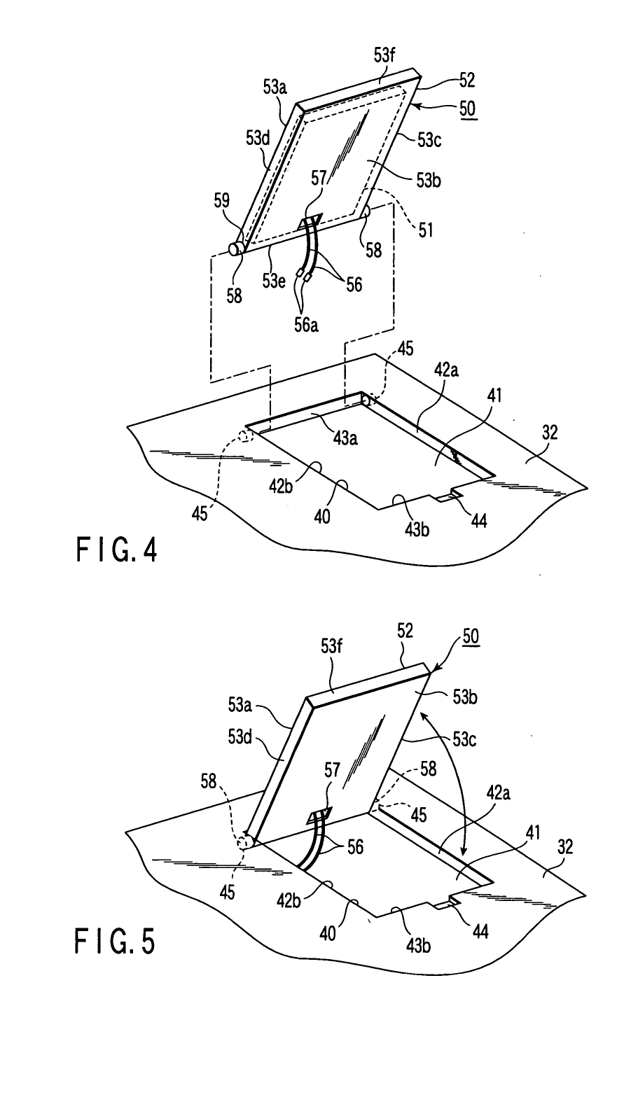

The speaker 51 is contained in the housing 52. The bottom wall 53b of the housing 52 has an opening 57 that is located close to the front wall 53e. As shown in FIG. 4, two wires 56 extend from the speaker 51. The wires 56 pass through the opening 57 and are led out of the housing 52. A terminal 56a is mounted on the distal end of either wire 56.

The top wall 53a of the housing 52 has a opening 54 that is almost circular. The opening 54 serves as sound-emanating section for emanating the sound generated by the speaker 51. A mesh 55 is fitted in the opening 54 (see FIGS. 1 to 3).

A pair of hinges 58 protrude from the side walls 53c and 53d of the housing 52; they can be pushed into the interior of the housing 52. More precisely, the side walls 53c and 53d have a hole 59 each. The hole 59 is located near the front wall 53e. The housing 52 contains two springs (not shown). The springs bias the hinges 58, pushing them out of the housing 52 through the holes 59 (see FIGS. 4 and 5).

The hinges 58 need not be those that can be pushed into the housing 52. Rather, they may be of the type that is elastically deformed or elastically deform the housing 20 when they are fitted into the hinge sockets 45.

Either speaker unit 50 is secured to the housing 20 in the following way. First, the terminals 56a on the wires 56 extending from the speaker 51 are electrically connected to the speaker terminals provided in the housing 20. Next, the hinges 58 are pushed into the housing 52. The speaker unit 50 is therefore partly held in the speaker receptacle 40, with its bottom wall 53b turned downwards (namely, with the opening 54 located at the top). Then, the speaker unit 50 is rotated down until the outer surface of its bottom wall 53b touches the bottom surface 41 of the housing 52. As a result, the speaker unit 50 is held, in its entirely, in the speaker receptacle 40, and both hinges 58 come into axial alignment with the hinge sockets 45. Biased by the springs (not shown), the hinges 58 protrude from the housing 52 and slip into the hinge sockets 45.

Thus, the housing 20 supports either speaker unit 50. The unit 50 can rotate around the common axis of the hinges 58, between two positions. At the first position (see FIGS. 1 and 2), the unit 50 lies down in the speaker receptacle 40. At the second position (see FIGS. 3 and 5), the unit 50 stands up, protruding from the speaker receptacle 40. As indicated above, the receptacle 40 is so deep that the unit 50 may lie down in it, with its upper surface positioned almost in flush with the upper surface 32 of the housing 20. Hence, the upper surface of the speaker unit 50 lies in flush with the upper surface 32 of the housing 20 while the unit 30 is fully held in the speaker receptacle 40.

As described above, the hinges 58 are fitted rather tight in the hinge sockets 45. Thanks to the friction between the hinges 58 and the sockets 45, either speaker unit 50 is firmly held whichever position it takes, the first position, the second position, or any other position between the first and second positions. Thus, the speaker unit 50 can be held, tilt at any desired angle to the upper surface 32 of the housing 20.

To hear well the sound coming from either speaker 51, the user needs only to insert a finger into the finger rest 44 and pull up the speaker unit 50 to any position where the unit 50 is inclined at a desired angle to the upper surface 32 of the housing 20.

As described earlier, the speaker unit 50 has an opening 54 that serves as sound-emanating section. Since the opening 54 is made in the top wall 53a of the housing 52, it is exposed outside the housing 20 even while the speaker unit 50 remains entirely held in the speaker receptacle 40.

Thus, the user can hear well the sound generated by the speaker 51 even if the speaker unit 50 is pulled up from the housing 20 for some reason. As long as the speaker unit 50 is held fully in the speaker receptacle 40, its top surface remains in flush with the upper surface 32 of the housing 20. Therefore, the speaker unit 50 will not hinder the user from operating the keyboard 23 and the like. Nor will it interfere with the display unit 2 as long as it is held entirely in the speaker unit 40.

As specified above, the speaker receptacles 40 are made in the outer surface 31 of the top wall 21a, or on the sides of the keyboard 23 and palm rest 24. Further, either speaker unit 50 provided on the housing 20 can be rotated between the first position where it lies down in the speaker receptacle 40 and the second position where it stands up, protruding from the speaker receptacle 40. Hence, both speakers 51 can send sound forth, directly to the person who is using the portable computer 1. That is, the portable computer 1 excels in the directivity of sound emanation.

Moreover, the speaker units 50 can be inclined at any desired angle to the upper surface 32 of the housing 20. They can therefore emanate sound in any direction the user of the computer 1 wants.

Furthermore, either speaker units 50 can be rotated between the first and second positions, by using a simple structure. Namely, two hinges 58 that project respectively from the side walls 53c and 53d of the unit 50 and the hinge sockets 45 made in the side surfaces 42a and 42b of the speaker receptacle 40 enable the speaker unit 50 to rotate so.

As indicated above, either speaker unit 50 has an opening 54 that serves as sound-emanating section. Made in the top wall 53a of the housing 52, the opening 54 is exposed outside the housing 20 even while the speaker unit 50 remains entirely held in the speaker receptacle 40. This enables the speaker 51 to emanate efficiently outside the housing 20, though the unit 50 lies down in the receptacle 40. Once the speaker unit 50 is pulled up from the receptacle 40 to the second position where it stands up, it can emanate the sound in a forward-up direction, to the ears of the person who is using the portable computer 1.

As already specified, the speaker receptacles 40 are located on the sides of the palm rest 24. In other words, the speakers 51 are arranged close to the front of the housing 20. This also helps to direct the sound from the speakers 51 to the user who sits in front of the personal computer 1.

Further, the housing 20 has two finger rests 44 in its upper surface 32, which are continuous to the rear surfaces 43b of the respective speaker receptacles 40. Either finger rest 44 makes it easy for the user to rotate the speaker unit 50 from the first position where the unit 50 lies down to the second position where the unit 50 stands up.

As specified above, the display unit 2 is so coupled to the housing 20 as to rotate between the closed position where it covers the keyboard 23 and the opened position where it exposes the keyboard 23. Further, either speaker unit 50 lies in flush with the outer surface 31 of the housing 20 while being entirely held in the speaker receptacle 40. Hence, the speaker units 50 hardly hinder the user from operating the keyboard 50. Nor will they interfere with the display unit 2 even while the display unit 2 remains at the closed position.

The present invention is not limited to the embodiment described above. Rather, various changes and modifications can be made within the scope and spirit of the invention.

1. An electronic apparatus comprising a housing having an outer surface and a keyboard provided on the housing and exposed outside the housing, wherein
the outer surface of the housing has a palm rest in front of the keyboard and a speaker receptacle on the side of the keyboard and the palm rest;
a speaker unit is provided in the speaker receptacle, and able to be rotated between a first position where the speaker unit is held in the speaker receptacle and a second position where the speaker unit protrudes from the speaker receptacle.

2. The electronic apparatus according to claim 1, wherein it is possible to adjust an angle between each of the speaker unit and the outer surface of the housing.

3. The electronic apparatus according to claim 1, wherein the speaker unit has two side walls, two hinges are provided on the side walls, the speaker receptacle has two side surfaces, and two hinge sockets are provided in the side surfaces of the speaker receptacle.

4. The electronic apparatus according to claim 1, wherein the speaker unit has a speaker which generates sound and a sound-emanating section which remains exposed while the speaker unit remains held in the speaker receptacle and which emanates the sound generated by the speaker unit.

5. The electronic apparatus according to claim 1, wherein the speaker receptacle is located on the side of the palm rest.

6. The electronic apparatus according to claim 1, wherein the speaker unit lies in flush with the outer surface of the housing while held in the speaker receptacles.

7. The electronic apparatus according to claim 1, wherein the outer surface of the housing has finger rest which is continuous to the speaker receptacle, and which is used to rotate the speaker units.

8. An electronic apparatus comprising a housing having an outer surface and a display unit coupled to the housing and being able to be rotated, wherein
a speaker receptacle is provided in the outer surface of the housing; and
a speaker unit is provided in the speaker receptacle, and is able to be rotated between a first position where the speaker unit is held in the speaker receptacle and a second position where the speaker unit protrudes from the speaker receptacle.

9. The electronic apparatus according to claim 8, wherein the outer surface of the housing has an upper surface exposed upwards.

10. The electronic apparatus according to claim 9, wherein a keyboard is provided on the upper surface, and the display unit is coupled to the housing and able to be rotated between a closed position and an opened position, said display unit covering the keyboard at the closed position and exposing the keyboard at the opened position.
